(19) United States
(12) Patent Application Publication
(10) Pub. No.: US 2009/0132915 A1
(43) Pub. Date: May 21, 2009

(54) VIEW SELECTION AND SWITCHING

(75) Inventors: Michael Scott McCraw, Sammamish, WA (US); Yifung Lin, Bellevue, WA (US); David Paul Hill, Remond, WA (US); Kathy K. Carper, Redmond, WA (US); Aliaksandr Bulankou, Redmond, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/942,879

(22) Filed: Nov. 20, 2007

(51) Int. Cl. G06F 3/00

(52) U.S. Cl. 715/700; 715/778; 715/781

(57) ABSTRACT

Application logic and user interfaces are separated to allow more than one interface or view to be easily employed for given application logic. A particular interface can be utilized to display data and/or facilitate interaction simply by identifying the interface. Available interfaces are identified to users for selection thereof. The specific interfaces and manner of identification can be filtered or otherwise controlled or arranged. Upon selection of an interface, data can be rendered accordingly. A transition can also be applied between switched interfaces.

### BACKGROUND

User experience (UX) refers to overall quality of experience of user interaction with a system. User experience design is multi-disciplinary incorporating teachings of psychology, engineering, and graphic design, among others. The goal is to facilitate interaction by identifying and catering to end user needs, desires, and limitations. As per computer systems, user experience pertains to human computer interaction (HCI) at user interfaces.

User interfaces enable users to interact with a computer, device, and software executed thereby. Interfaces receive input from users to manipulate a computer system utilizing various capture mechanisms including, keyboards, keypads, pointing devices and the like. Interfaces output data and responses to user manipulations via text, graphics, audio, and/or video.

User interfaces have evolved substantially in terms of user experience. Initially, computer interaction was accomplished by entering text commands via keyboards. However, these commands were numerous, complex, and not easily discoverable. Graphical user interfaces (GUIs) were subsequently invented to address these and other deficiencies. In particular, GUIs employ graphical elements and a pointing device such as a mouse to trigger operations rather than typing commands. For example, various metaphors such as windows and a desktop were utilized to facilitate interaction with other graphic elements. GUIs further evolved from primitive monochrome graphics to much smoother and colorful interface elements. Current development continues to leverage gains in computational power, memory and the like to present even better graphical interfaces.

User experience and specifically graphical user interfaces are very important to applications. New functionality implemented by an application is of little value to consumers if it is not easy to use. To this end, one application design goal is usability. Also generally referred to as user friendliness, such factors include intuitive navigation, ease of learning, efficiency of use, as well as subjective satisfaction. Accordingly, programmers need to examine who their application users are including their knowledge level, background, and learning capacity, among other things and develop an interface based on these factors. As a result, a single user interface is conventionally provided, tightly coupled to backend programmatic logic, that seeks to address the average application user.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to selection and switching views or user interfaces. Views and application logic can be separated or at most loosely coupled rather than tightly coupled or integrated to facilitate flexible, compositional construction of applications with different views. In accordance with an aspect of the disclosure, simple identification of a view in a declaration, for example, can trigger binding of the view to associated application logic. According to another aspect of the disclosure, end users can select and switch views as desired at runtime without additional work by developers. Further yet, views presented for selection can be filtered and/or ordered to improve user productivity according to yet another aspect of the disclosure. In accordance with still another aspect of the disclosure, transitions can be provided when switching between views to improve user experience.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a static view selection system in accordance with a disclosed aspect.

FIG. 2 is a block diagram of a dynamic view selection system in accordance with an aspect of the disclosed subject matter.

FIGS. 3a-c illustrate exemplary styling of a selection mechanism according to an aspect of the disclosure.

FIG. 4 is a block diagram of a dynamic view selection system including a filter in accordance with an aspect of the disclosure.

FIG. 5 is a block diagram of a dynamic view selection system including an order component according to an aspect of the disclosure.

FIG. 6 is a block diagram of a dynamic view selection system that applies transitions for view switches in accordance with a disclosed aspect.

FIG. 7 is a block diagram of an extensible view system in accordance with an aspect of the subject disclosure.

FIG. 8 is a flow chart diagram of static view specification method according to a disclosed aspect.

FIG. 9 is a flow chart diagram of a view/UI rendering method in accordance with an aspect of the disclosure.

FIG. 10 is a flow chart diagram of a view selection method according to an aspect of the disclosure.

FIG. 11 is a schematic block diagram illustrating a suitable operating environment for aspects of the subject disclosure.

FIG. 12 is a schematic block diagram of a sample-computing environment.

### DETAILED DESCRIPTION

Systems and methods of view selection and switching are described in detail hereinafter. Application logic and interfaces are implemented separately to enable more than one interface or view to by utilized in conjunction with the application logic. Support is provided for specification of a view for application logic by mere identification. Further, views can be provided to users for selection and subsequent provisioning dynamically at runtime. These views can be selectively afforded and ordered, among other things, as a function of contextual information including user identities, roles, and/or permissions, for instance. Still further yet, transitions can be applied when switching between views.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

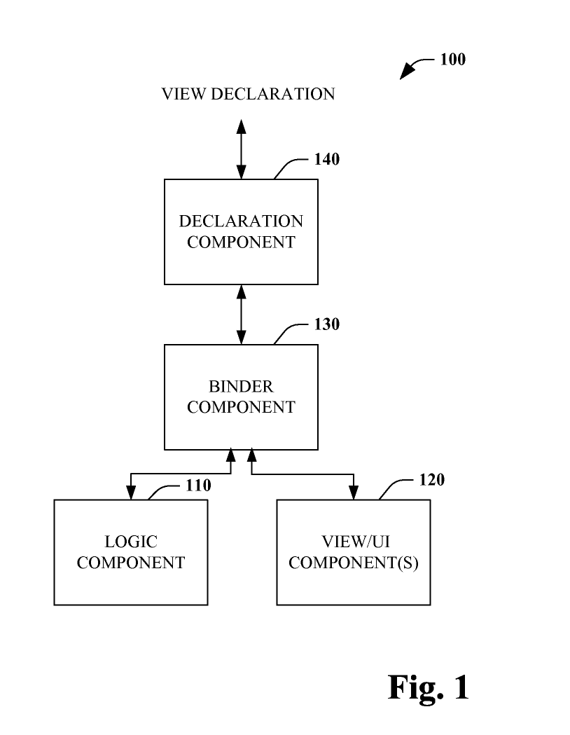

Referring initially to FIG. 1, a static view selection system 100 is illustrated in accordance with an aspect of the claimed subject matter. Views/interfaces and logic are implemented separately or in a loosely coupled manner. As illustrated, the system 100 includes a logic component 110 and one or more view or user interface (UI) components 120. Here, the logic component 110 defines core application functionality in a discrete and reusable part. For example, the logic component 110 can retrieve data from one or more sources and process data in specified ways. The view component 120 defines a single view or user interface responsible for receiving input from users and/or rendering data. More than one view component 120 can be applied with respect to single logic component 120. In other words, there is a one-to-many relationship between logic component 110 and view/UI component(s) 120.

Various styles of displaying information (e.g., charts, tables, graphs . . . ) give end users different advantages in viewing and analyzing underlying data. Accordingly, the ability to display one set of data in multiple ways is important. Different users have different preferences in the way they want to interact with an application. For example, some people prefer to see their file directory as icons, others prefer to view this information as a list, and some want a thumbnail of the actual content. Therefore, it is advantageous for applications to support multiple user interfaces and be able to change views easily to display underlying data and logic in different manners.

Conventionally, developers are required to implement logic every time they need to produce a different display or interaction with their application. In fact, the logic and interface are tightly integrated in complex and inseparable ways. As a result, multiple interfaces are time as well as cost prohibitive. By separating logic from the view over the logic, different displays or interactions can supported more easily.

It should be appreciated that the logic component 110 and view/UI component(s) 120 need not be completely separate. In one embodiment, these components can be loosely coupled. For example, situations may occur where interaction with logic or data produced thereby is the same across different interfaces. In this case, a portion of an application user interface can be encapsulated within the logic component 110.

Furthermore, the view/UI component(s) 120 can interact with a shell. A shell is a user interface provided by a host application that defines the overall look and feel of the host application and provides screen real estate. The view/UI component(s) 120 can integrate with a shell's user interface. For example, the shell can be a computer operating system that provides a window for use by a view/UI component 120.

The logic component 110 and a view/UI component(s) 120 can be linked or bound by binder component 130. In one embodiment, the binder component 130 can provide or act as an interface such as an application-programming interface (API) providing a means for communicating between the two distinct components 110 and 120. Other embodiments are also possible and contemplated. By way of example and not limitation, the binder component 130 can integrate instances of the logic component 110 and view component 120. In any event, the binder component 130 enables a view or interface to execute together with application logic.

Declaration component 140 receives or retrieves information regarding what view component 120 is to be bound a logic component 110. This information can be transmitted or otherwise made available to the communicatively coupled binder component 130 for use thereby. In accordance with one aspect, views or interfaces can be linked or bound to logic by simple identification. For example, a developer can simply identify a view component 120 to be bound to a logic component 110. This could be accomplished with a markup language such as XMAL (eXtensible Markup Application Language), among others, by a specifying a type. If no view is specified for logic via the declaration component 140, a default view can be bound. In one instance, the declaration component 140 can be part of an API including the binder component 130. However, the claimed subject matter is not limited thereto.

By way of example and not limitation, consider the follow pseudo-code where a “Part” corresponds to application logic and a “PartView” denotes a view or user interface:

SomePart
[DefaultView(typeof(SomePartView1))]
public partial class SomePart : Part
{ }
SomePartView1
[ViewExtensionInfo(DefaultViewTechnologies.PresentationFoundation,
“PartView Title”, “PartView Description”,
typeof(ISomePartViewContract))]
public partial class SomePartView1 : PartView
{ }
SomePartView2
[ViewExtensionInfo(DefaultViewTechnologies.PresentationFoundation,
“PartView Title”, “PartView Description”,
typeof(ISomePartViewContract))]
public partial class SomePartView2 : PartView
{ }

Here, a single part “SomePart” is declared as well as two views “SomePartView1” and “SomePartView2.” The following code snippet illustrates how a view can be selected based on type, namely “PartViewType”:

<PartPane Part=”{Binding SomePart}” PartViewType=”{x:Type
SomePartView2}”/>

In this case, the second view “SomePartView2” is bound to the part “SomePart.” More specifically, “PartPane” inherits from “Pane” which can inherit from “ContentControl” of a presentation system. A new property on “PartPane” is added to enable developers the ability to select a “PartView” associated with a “Part” (self-contained logic). Developers can also specify which view to use more directly by setting the “PartViewType” property directly as follows:

public static readonly DependencyProperty PartViewTypeProperty =
DependencyProperty.Register(
“PartViewType”, typeof(Type), typeof(PartPane), new
PropertyMetadata(null, new
PropertyChangedCallback(OnPartViewTypeChanged)));

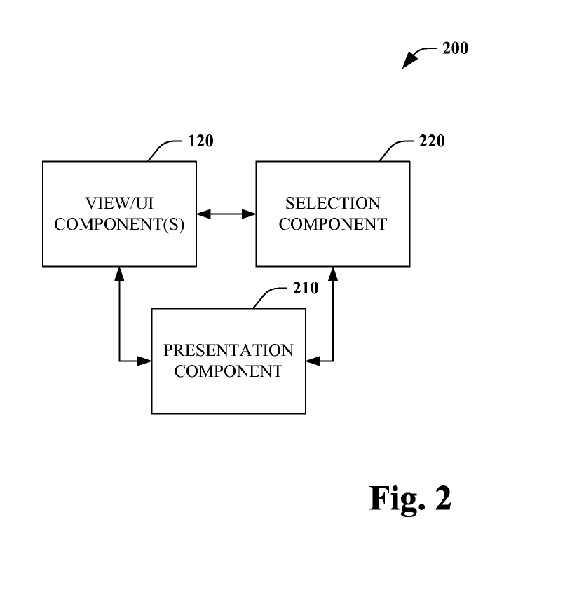

Turning attention to FIG. 2, a dynamic view selection system 200 is depicted in accordance with an aspect of the claimed subject matter. Presentation component 210 presents, renders or otherwise provisions data and/or associated application logic in accordance with a given view/UI component 120. Initially, a default or developer specified view or user interface component 120 can be rendered by the presentation component 210. Selection component 220 provides a mechanism to enable users to change views at runtime, for instance from a default to another available view. By way of example, the selection component 220 can identify available views to a user utilizing a drop down list or other mechanism and subsequently receive or identify a user view selection. Upon selection of a view, the presentation component 210 can present or render data in accordance with the selected view/UI component 120. This can be accomplished by binding or linking the selected view to the separate, underlying application logic in a manner at least similar to that previously described with respect to system 100. In any event, a backend framework or architecture can enable easy switching of views without additional developer effort in contrast to that conventionally required.

For purposes of clarity and understanding and not limitation, consider a scenario in which a user wants to monitor her stock portfolio closely utilizing a custom stock monitor where she can specify stocks to track. She can first write the custom application logic to acquire stock information from a web service. Subsequently, multiple views can be applied in conjunction with the logic to view the same data in different ways. More specifically, she can select from ten available views shown at runtime by identifying a particular view by name from a drop down menu, for instance. Similar scenarios exist for weather and RSS (Really Simple Syndication) posts.

It is to be noted that the selection component 220 can interact with, or be encapsulated by, the presentation component 210. For example, the selection component 220 can be embodied as a selection interface or menu that forms part of a window, frame, or chrome surrounding an area to be occupied by a default or selected view or user interface. Further, this selection interface can also be styled in various ways. These styles can be specified in accordance with a previous exemplary pseudo-code as follows:

```
<PartPane Part=”{Binding SomePart}”>
<PartPaneStyle>
    <! -- Some Style -->
</PartPaneStyle>
      </PartPane>
```

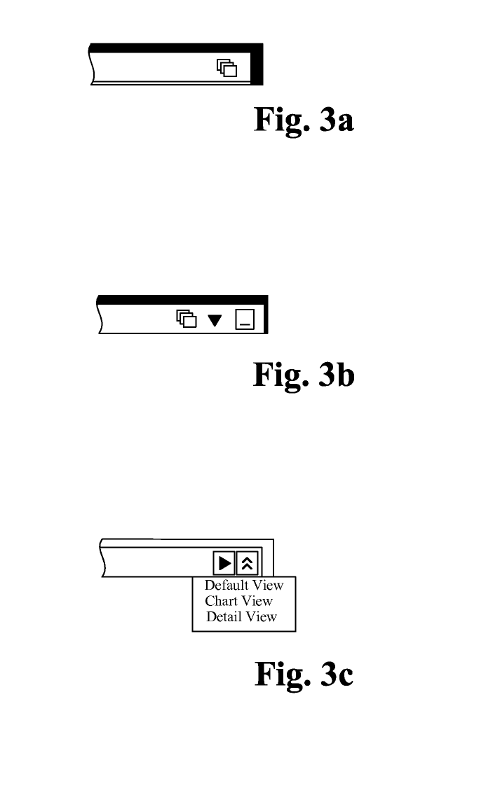

FIGS. 3a-c illustrate portions of a few exemplary selection interfaces. As shown in FIG. 3a, the top, right corner of a window can be styled as illustrated with a selectable graphical element (e.g., staggered boxes) to initiate identification of available views. An alternative style is depicted in FIG. 3b. Here, the styling differences of the window itself are subtle, although differences may exist in coloring that is not shown. Further included are other graphical elements for presenting available views in a different manner and expanding the window, among other things. FIG. 3c illustrates yet another embodiment of a selection mechanism where graphical elements exist for presenting a list to the side of the window or as a drop down menu. Here, the drop down menu is shown as activated and identifies three views that can be selected by a user “Default View,” “Chart View,” and “Detailed View.”

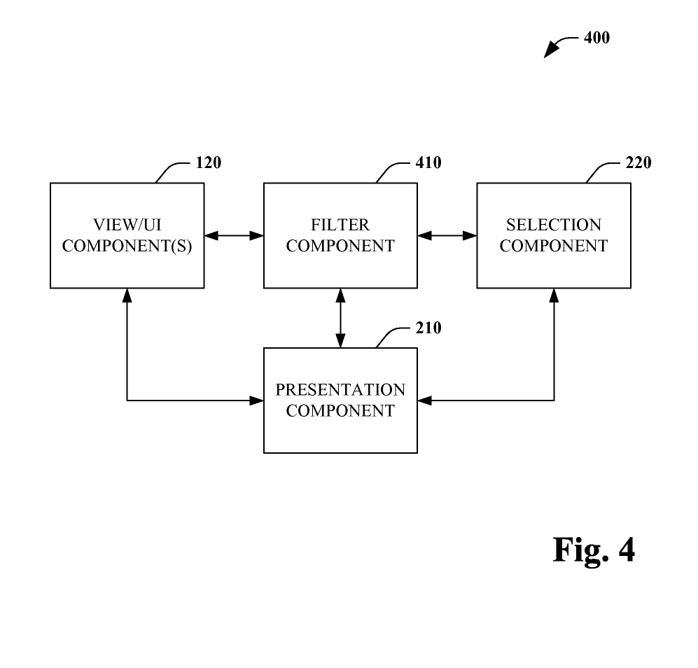

Turning attention to FIG. 4, a dynamic view selection system 400 is depicted according to an aspect of the claimed subject matter. The system 400 resembles system 200 of FIG. 2 including the view/UI component(s) 120, presentation component 210 and selection component 220, as previously described. In brief, the presentation component 220 renders data provisioned by associated logic in accordance with a dynamically selected view identified via the selection component 220. In addition, the system 400 includes a filter component 410 communicatively coupled to the other components 120, 210 and 220. The filter component 410 filters or restricts views as a function of any number of factors including view technology, user identity, user role, user permissions, and/or group membership, amongst other contextual information. A filter can be applied to all available view/UI components 120 for a given set of application logic, for example, such that only a subset of views or user interfaces are shown and available for selection by a user via selection component 220 and ultimately rendering by the presentation component 210.

In accordance with the continuing exemplary pseudo-code, a filter can be designated for execution before generating a list of available views to show users as follows:

<PartPane Part=”{Binding SomePart}” PartViewFilter=”{x:Type
SelectionFilter}”/>

In other words, a “PartViewFilter” is set to “SelectionFilter” for a given “Part.” Accordingly, an available filter need only be appropriately identified by name.

Consider a real estate application including appropriate business logic and many views, for example. Based on a user's role or position, only a subset of views will be available to her. For instance, a user may have only four out of ten views available, while a real estate agency may be able to see six out of ten views, and only an administrator is able to see all ten views.

The filter component 410 can operate with respect to any contextual information that is available thereto. Accordingly, filtering can be arbitrarily simple, or complex. For instance, filtering can occur based solely on a user identity. Alternatively, the filter component 410 can infer the most appropriate views based on a variety of contextual factors including historical usage and/or preferences, amongst others. Further, various technologies can be utilized to provision context information. For example, global satellite positioning systems (GPS) can provide user location data to enable filtering based on location.

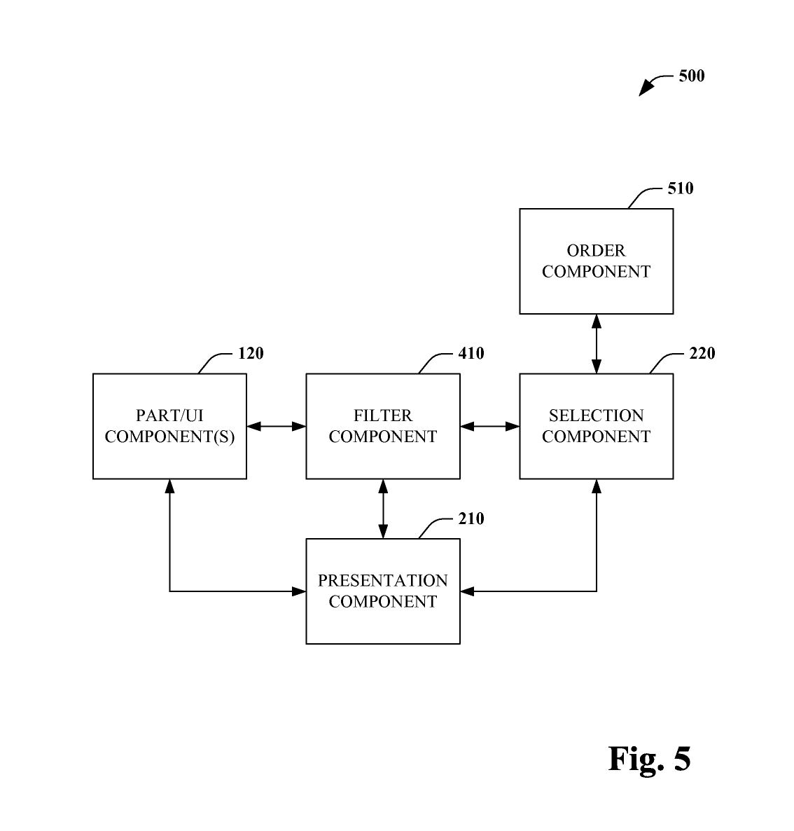

FIG. 5 depicts another dynamic view selection system 500 in accordance with an aspect of the claimed subject matter. Similar to systems 200 and 400, the system 500 includes the view/UI component(s) 120, presentation component 210, selection component 220, and filter component 410, as described previously. In sum, the selection component 220 provides one or more filtered views for selection by a user and rendering by the presentation component 210. In addition to controlling the views available for selection, system 500 includes an order component 510 that organizes the presentation of selectable views. In particular, the order component 510 can order or arrange a list of views/UIs in a drop down menu, for example, by relevance to a particular user to improve user experience. The same or similar contextual information utilized to filter views can also be employed to organize views for selection. For example, although ten views are available to a user, given the current context (e.g., time, date, location, data . . . ) she may only typically utilize one view. That view can be ordered first amongst a plurality of views in a drop down menu. Additionally, or alternatively, relevance can be indicated graphically using different colors, fonts, and/or sizes, among other things.

View ordering or organization logic can by specified by a programmer during program development. In accordance with one aspect, users can simply provide an integer that sets a view's order explicitly or specify custom logic for determining order of views at runtime. Exemplary pseudo-code for setting order by integer is:

[ViewExtensionInfo(DefaultViewTechnologies.PresentationFoundation,
“PartView Title”, “PartView Description”,
typeof(ISomePartViewContract), 1)]
public partial class SomePartView1 : PartView
{ }

In this case, “SomePartView1” is specified as the first view to appear. Order can also by set utilizing custom logic as follows:

<PartPane Part=”{Binding SomePart}”
InitalizePartViews=”ViewLogicOrder”/>

Here, views binding to “SomePart” are organized in accordance with the order specified by “ViewLogicOrder,” which can be arbitrarily complex.

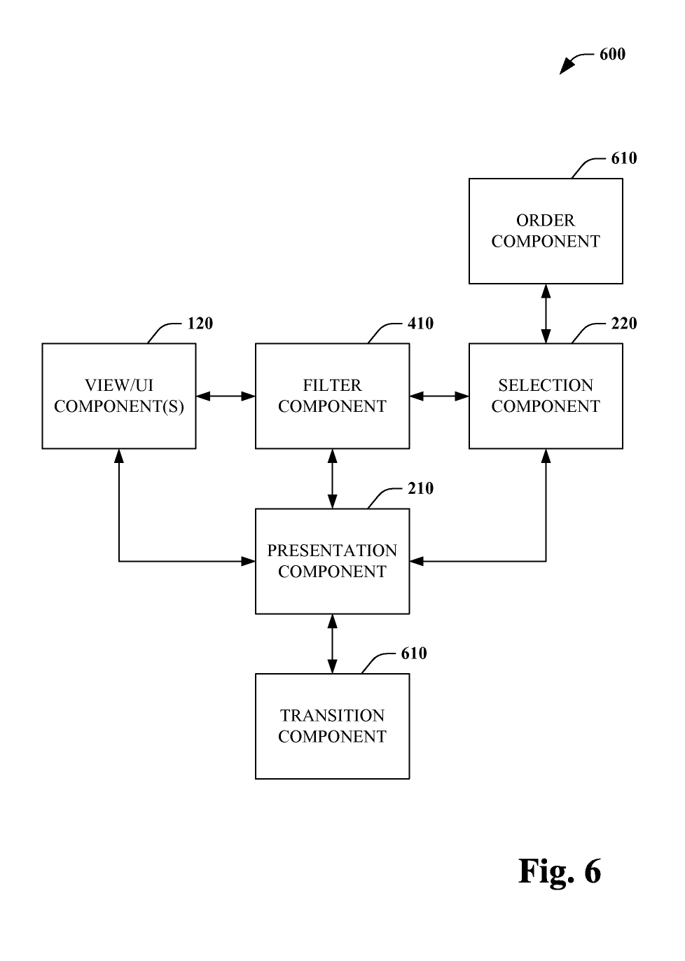

FIG. 6 illustrates yet another dynamic view selection system 600 according to an aspect of the claimed subject matter. In addition to the components described above with respect to systems 200, 400, and 500 of FIGS. 2, 4 and 5, respectively, the view selection system 600 includes a transition component 610. The transition component 610 applies transitions between view switches. Transitions can correspond to various animations, among other things, including fades, cube rotations, and billboard rotations, for example. Sound, amongst other things, can also be utilized alone or in combination with graphical transitions. The transition component 610 interacts with the presentation component 210 such that a specified transition is applied when switching from a first view to a second view. In accordance with the ongoing exemplary pseudo-code, transitions can be specified as follows:

<PartPane Part=”{Binding SomePart}”
ViewSwitchTransition=”RotateTransition”/>

In this case, a “RotateTransition” is specified for transitions between views associated with “SomePart.”

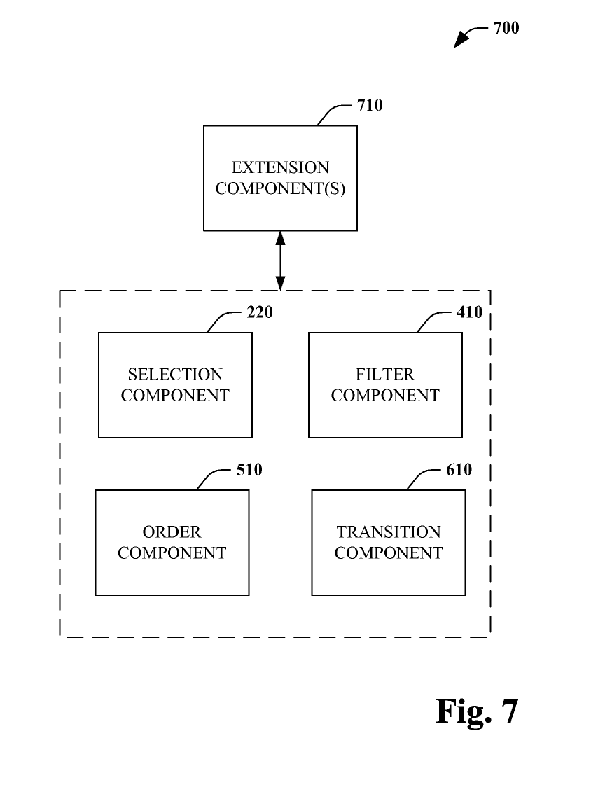

Referring to FIG. 7, a view extension system 700 is illustrated in accordance with an aspect of the claimed subject matter. One or more extension components 710 can interact with the selection component 220, filter component 410, order component 510, and transition component 610 to extend associated functionality. The extension component(s) 710 is a mechanism that enables injection or importation of external or third party functionality (e.g., provided by an entity other than the system and system user) from plug-ins, for instance. Each component can include a set of initial functionality. However, each component is also extendable or pluggable. For instance, various selection styling and/or functionality can be injected and supported by the selection component 220. Additional third party filters can be added to the system and applied by the filter component 410. Similarly, various ordering functionality can be provided externally and employed by the order component 510. Still further yet, additional transitions can be registered and employed by transition component 610. It is to be further appreciated that component or system extensions can be added and subsequently employed at runtime. By way of example and not limitation, a filter is pluggable, and users can switch to a newly provided filter at runtime.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the filter component 410 and/or order component 510 can utilizes such mechanisms to infer or intelligently determine appropriate views and orders, respectively.

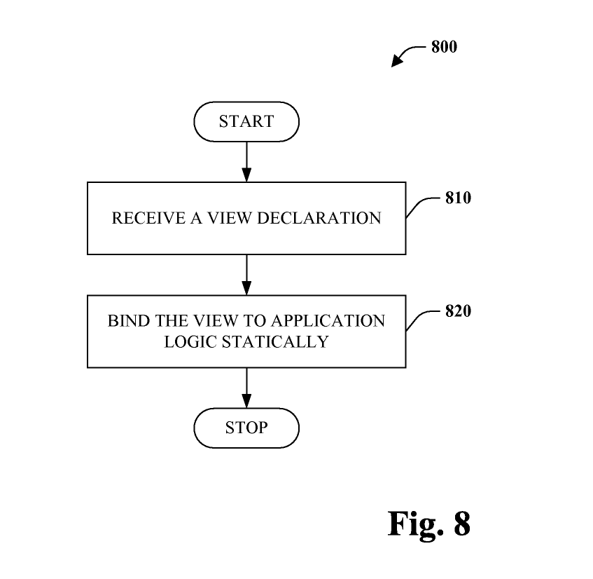

In view of the exemplary systems described supra, methodologies that may be implemented in accordance with the disclosed subject matter will be better appreciated with reference to the flow charts of FIGS. 8-10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 8, a static view specification method 800 is illustrated in accordance with an aspect of the claimed subject matter. As mentioned above, views and application logic can be implemented separately or at the most loosely coupled. This enables a more compositional approach to application development wherein views are easily applied to associated application logic and data afforded thereby. At reference numeral 810, the method 800 receives or otherwise acquires a declaration identifying a view to be employed in connection with a particular set of logic. In accordance with one embodiment, the declaration can be specified in a markup language and view can as a type. At numeral 820, the identified type is bound statically to associated application logic. Implementing applications in this manner by simply identify a desired view improves programmatic productivity many times over development of monolithic applications with a tightly coupled and integrated logic and user interface. Furthermore, views can easily be switched statically or later at runtime.

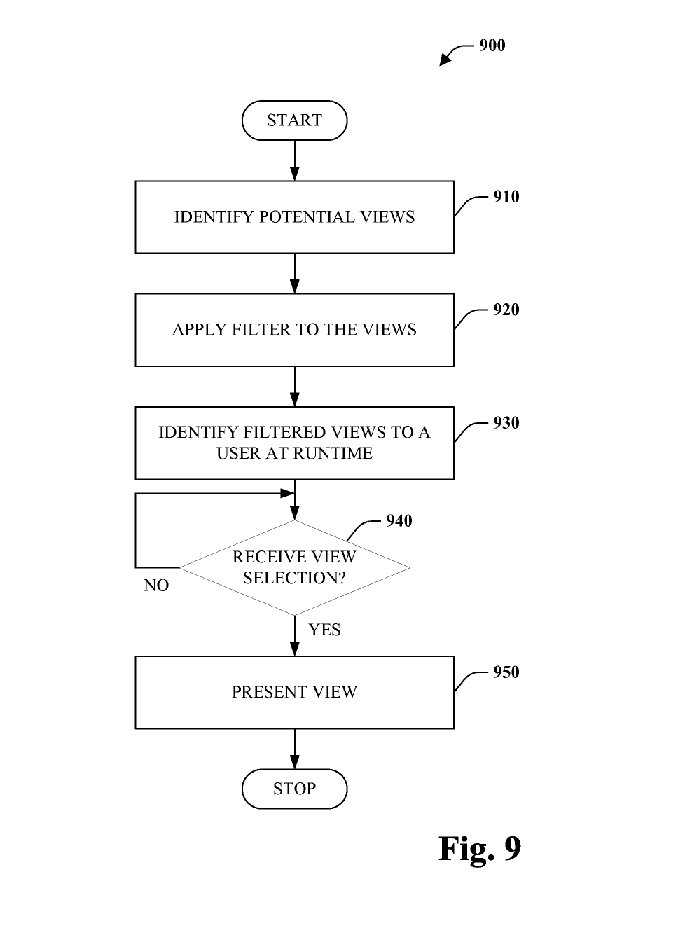

FIG. 9 depicts a method of view or user interface rendering 900 in accordance with an aspect of the claimed subject matter. At reference numeral 910, potential views or user interfaces are identified for a particular set of application logic, for example. A filter is applied to the potential views to suitable views for a particular user at numeral 920. Filtering can occur as a function of any available context information including without limitation user identity, group affiliation, role, permissions, and/or location. At reference 930, filtered views are identified to end users at runtime. Such views can be presented in a separate user interface element as in a drop down menu of a window or chrome. At numeral 940, the method 900 continues to loop until a view selection is received. This can correspond to a user identifying a view in a drop down menu. Once a view is selection is received, the method 900 continues at 950 where the selected view is presented. It is to be appreciated that when switching views a transition associated with the application logic or individual views can be applied rather than simply swapping views to improve user experience.

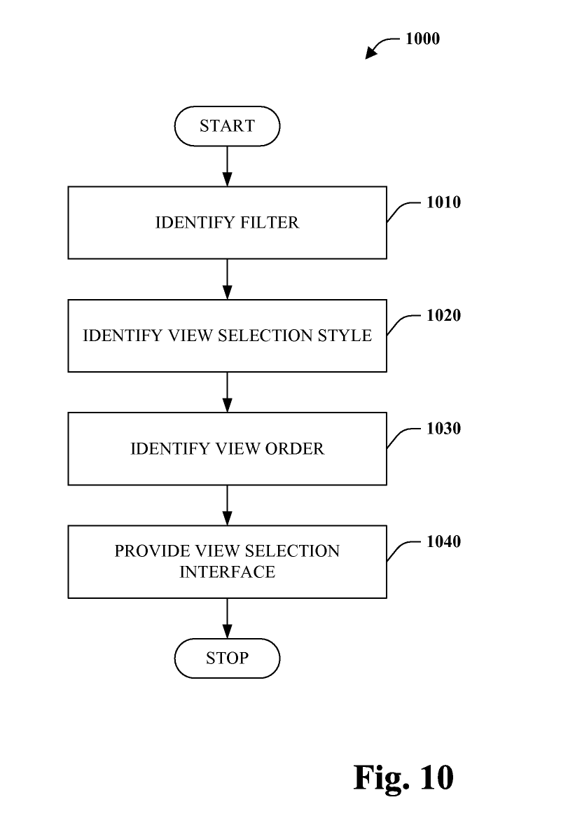

Referring to FIG. 10, a flow chart diagram of a view selection method 1000 is illustrated in accordance with an aspect of the claimed subject matter. At reference numeral 1010, a view selection filter is identified. The filter enables a subset of views to be identified at runtime as a function of contextual information. At numeral 1020, a view selection interface style is identified. For instance, the format, color, and interface mechanisms can be identified. A view ordering mechanism is identified at 1030. This determines the order or organization of filtered views. At reference numeral 1040, the view selection interface is provided in accordance with identified filter, style, and order. For example, window can be provided with a graphical element that initiates a drop down menu that provides filtered views in order of relevance (e.g., top most relevant bottom least relevant). A user can then select a view for presentation utilizing this mechanism.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

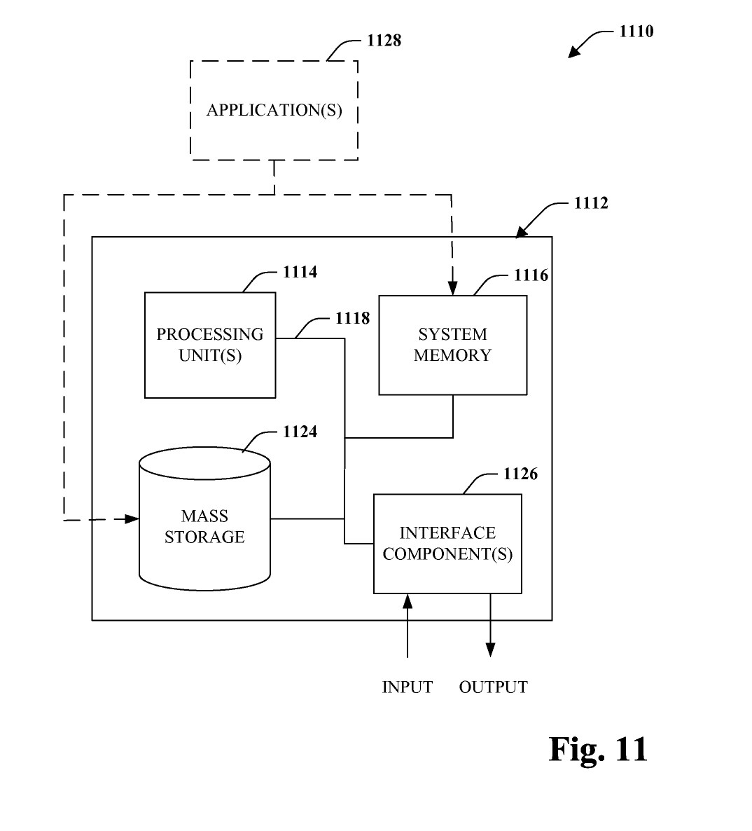

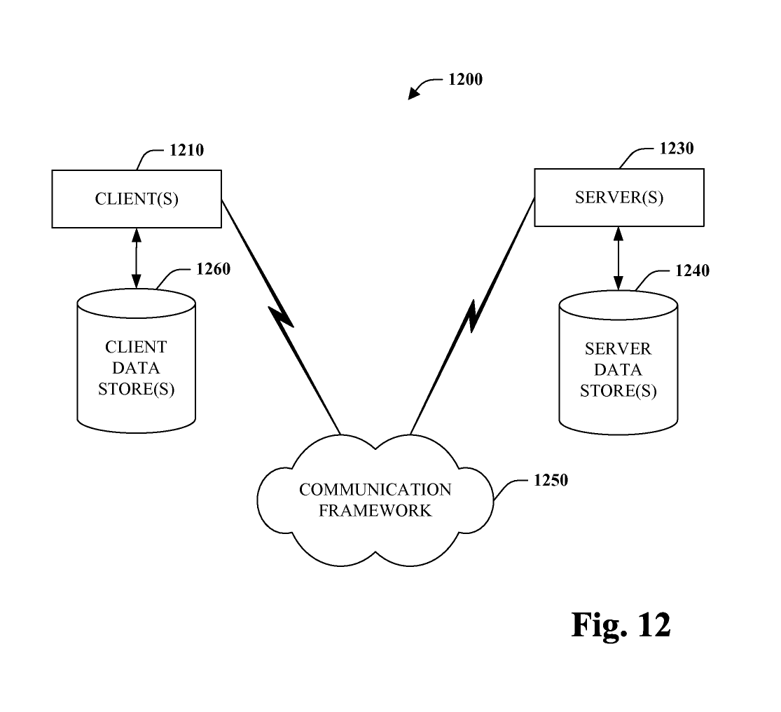

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 11, an exemplary environment 1110 for implementing various aspects disclosed herein includes a computer 1112 (e.g., desktop, laptop, server, hand held, programmable consumer or industrial electronics . . . ). The computer 1112 includes a processing unit 1114, a system memory 1116, and a system bus 1118. The system bus 1118 couples system components including, but not limited to, the system memory 1116 to the processing unit 1114. The processing unit 1114 can be any of various available microprocessors. It is to be appreciated that dual microprocessors, multi-core and other multiprocessor architectures can be employed as the processing unit 1114.

The system memory 1116 includes volatile and nonvolatile memory. The basic input/output system (BIOS), containing the basic routines to transfer information between elements within the computer 1112, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1112 also includes removable/non-removable, volatile/non-volatile computer storage media. FIG. 11 illustrates, for example, mass storage 1124. Mass storage 1124 includes, but is not limited to, devices like a magnetic or optical disk drive, floppy disk drive, flash memory, or memory stick. In addition, mass storage 1124 can include storage media separately or in combination with other storage media.

FIG. 11 provides software application(s) 1128 that act as an intermediary between users and/or other computers and the basic computer resources described in suitable operating environment 1110. Such software application(s) 1128 include one or both of system and application software. System software can include an operating system, which can be stored on mass storage 1124, that acts to control and allocate resources of the computer system 1112. Application software takes advantage of the management of resources by system software through program modules and data stored on either or both of system memory 1116 and mass storage 1124.

The computer 1112 also includes one or more interface components 1126 that are communicatively coupled to the bus 1118 and facilitate interaction with the computer 1112. By way of example, the interface component 1126 can be a port (e.g., serial, parallel, PCMCIA, USB, FireWire . . . ) or an interface card (e.g., sound, video, network . . . ) or the like. The interface component 1126 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1112 to output device(s) via interface component 1126. Output devices can include displays (e.g., CRT, LCD, plasma . . . ), speakers, printers, and other computers, among other things.

FIG. 12 is a schematic block diagram of a sample-computing environment 1200 with which the subject innovation can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing the aspects of the subject innovation, for example. One possible communication between a client 1210 and a server 1230 may be in the form of a data packet transmitted between two or more computer processes.

The system 1200 includes a communication framework 1250 that can be employed to facilitate communications between the client(s) 1210 and the server(s) 1230. The client(s) 1210 are operatively connected to one or more client data store(s) 1260 that can be employed to store information local to the client(s) 1210. Similarly, the server(s) 1230 are operatively connected to one or more server data store(s) 1240 that can be employed to store information local to the servers 1230.

Client/server interactions can be utilized with respect with respect to various aspects of the claimed subject matter. For example, various extensions or plug-ins (e.g., selection, filter, order, transition . . . ) can be downloaded from server(s) 1230 to client(s) 1210 executing an application across the network framework 1250. Further, application logic can acquire data running on a client 1210 can acquire data from a web service provided by one or more servers 1230. Still further yet, applications utilizing the described view/logic separation or loose coupling and associated mechanisms can be distributed across client(s) 1210 and servers 1230 in a myriad of ways and communicate over the network framework 1250.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. A user interface system, comprising:
a component that acquires a view type declaration; and
a binder component that binds a view to a discrete and reusable set of application logic in accordance with the declaration.

2. The system of claim 1, the type declaration is specified in a markup language.

3. The system of claim 1, multiple views are bound to the logic.

4. The system of claim 3, further comprising a selection component that identifies available views for selection by a user at runtime.

5. The system of claim 4, the selection component implements a selection strategy in accordance with a particular visual style

6. The system of claim 4, the views are identified in a drop down list

7. The system of claim 4, further comprising a filter component that controls access to views.

8. The system of claim 4, further comprising a component that renders a selected view.

9. The system of claim 4, a component that orders the views for selection by relevancy to a user.

10. The system of claim 1, the view is a plug-in.

11. A computer implemented presentation method, comprising:
identifying a view selected from a plurality of views by a user at runtime; and
rendering data provisioned by application logic in accordance with an identified view, the logic and the view are implemented separately.

12. The method of claim 11, further comprising applying a filter to views provided to a user for selection.

13. The method of claim 12, further comprising changing filters at runtime.

14. The method of claim 12, further comprising acquiring a filter from a third party.

15. The method of claim, 11, further comprising ordering views provided to a user as a function of user relevance.

16. The method of claim 11, further comprising executing a transition between a first view and a second view.

17. The method of claim 16, further comprising receiving a transition from a third party.

18. The method of claim 11, further comprising registering a third-party view for use.

19. A view switching system, comprising:
means for filtering user interfaces presented to users for selection;
means for identifying a selected user interface at runtime; and
means for displaying data afforded by interface independent application logic in accordance with the selected interface.

20. The system of claim 19, further comprising a means for displaying a transition when switching between interfaces.
